(19) United States
(12) Patent Application Publication
(10) Pub. No.: US 2012/0181374 A1
(43) Pub. Date: Jul. 19, 2012

(54) MONOPULSE SPIRAL MODE ANTENNA COMBINING

(75) Inventor: Brett A. Williams, Iowa City, IA (US)

(73) Assignee: LOCKHEED MARTIN CORPORATION, Grand Prairie, TX (US)

(21) Appl. No.: 13/388,055

(22) PCT Filed: Jul. 30, 2010
(86) PCT No.: PCT/US10/43823

§ 371 Date: Apr. 9, 2012

Related U.S. Application Data
(60) Provisional application No. 61/230,476, filed on Jul. 31, 2009.

(51) Int. Cl. F42B 15/01; H01Q 1/42; H01Q 1/28

(52) U.S. Cl. 244/3.19; 343/705; 343/872

(57) ABSTRACT

A technique employing one or more conformal, spiral antenna for use in a vehicle such as a missile. The technique includes both an apparatus and a method. The apparatus includes a radome or missile body and a conformal, spiral antenna mounted in the radome or missile body. The method is one for use in operating a missile, comprising transmitting and receiving signals through a plurality of conformal, spiral antennae mounted in a radome or missile body. This may include in some variants transmitting and receiving signals through a plurality of conformal, spiral antennae mounted in a radome or missile body; and guiding the missile from information obtained from signals receive through the antennae.

The priority of U.S. Provisional Application Ser. No. 61/230,476, entitled “Monopulse Spiral Mode Antenna Combining”, filed Jul. 31, 2009, in the name of the inventor Brett A. Williams and commonly assigned herewith, is hereby claimed under 35 U.S.C. §119(e). This application is also hereby incorporated by references for all purposes as if set forth verbatim herein.

### BACKGROUND

1. Field of the Invention

The present invention pertains to antennas for use in homing on and intercepting missiles.

2. Description of the Related Art

This section of this document is intended to introduce various aspects of the art that may be related to various aspects of the present invention described and/or claimed below. This section provides background information to facilitate a better understanding of the various aspects of the present invention. As the section's title implies, this is a discussion of related art. That such art is related in no way implies that it is also prior art. The related art may or may not be prior art. It should therefore be understood that the statements in this section of this document are to be read in this light, and not as admissions of prior art.

One approach to resolving antenna issues arising from the lack of space available in airborne bodies such as aircraft or missiles is a surface mounted solution. Several options have been considered. While fractal antennas provide a surface mount option, such devices tend to suffer from multiple frequency notches over wide bands, which nonetheless may fit within atmospheric absorption windows. Another option is the log-periodic spiral antenna considered to be circularly polarized although it is actually slightly elliptical. It provides a planar surface (though a back-cavity is required intruding into airframe) and is broadband, from 2-18 GHz.

Some applications use spiral antennas housed inside the radome, facing forward, using peak mainbeam gain on the antenna's mechanical axis, using both modes (in direction finding they call sum antenna patterns “M1” or “mode 1”, and difference patterns “M2” or “mode 2”). However, these antennae cause significant problems in many applications.

The present invention is directed to resolving, or at least reducing, one or all of the problems mentioned above.

### SUMMARY OF THE INVENTION

A technique employing one or more conformal, spiral antenna for use in a vehicle such as a missile. The technique includes both apparatus and method.

Thus, in a first aspect, the apparatus comprises a radome or missile body and a conformal, spiral antenna mounted in the radome or missile body. In one variant, a plurality of conformal, spiral antennae mounted in the radome or missile body, which is joined with a missile body as part of a missile. The missile also includes means for guiding the missile responsive to information obtained through the spiral antennae.

And, in a second aspect, the method is for use in operating a missile, comprising transmitting and receiving signals through a plurality of conformal, spiral antennae mounted in a radome or missile body. This may include in some embodiments transmitting and receiving signals through a plurality of conformal, spiral antennae mounted in a radome or missile body; and guiding the missile from information obtained from signals received through the antennae. It may also include, in some embodiments, transmitting and receiving uplink and satellite positioning system (e.g., Global Positioning System, or “GPS”) signals through a single antenna.

The above presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

### BRIEF DESCRIPTION OF THE DRAWINGS

The invention may be understood by reference to the following description taken in conjunction with the accompanying drawings, in which like reference numerals identify like elements, and in which:

FIG. 1 shows selected portions of the hardware and software architecture of a computing apparatus such as may be employed in some aspects of the present invention;

FIG. 2 depicts a radome and conformal spiral antenna disposed therein in accordance with one particular embodiment of the present invention;

FIG. 3A-FIG. 3B depict variants of the embodiment in FIG. 2;

FIG. 4 depicts a missile to which a variant of the apparatus of FIG. 2 has been affixed;

FIG. 5 is a block diagram of selected portions of the hardware and software architecture for a computer-implemented guidance and navigation control system of a means for guiding the missile of FIG. 4 responsive to information obtained through the spiral antennae first shown in FIG. 2;

FIG. 6A-FIG. 6B illustrate the construction of one particular embodiment of the spiral antenna of FIG. 2;

FIG. 7 depicts a spiral power pattern for one particular implementation of a spiral antenna;

FIG. 8 provides an example of strongly squinted single-arm beam patterns for a second spiral antenna;

FIG. 9 shows M2 patterns from another spiral antenna alternative to that of FIG. 7 and FIG. 8;

FIG. 10 compares patterns in amplitude v. angle off boresight for the spiral antennae represented in FIG. 7-FIG. 9;

FIG. 11 compares present sum and absolute difference curves for the three spiral antennae represented in FIG. 7-FIG. 9;

FIG. 12 compares the beta curves for the three spiral antennae represented in FIG. 7-FIG. 9;

FIG. 13A-FIG. 13B graphically represent the angle reconstruction employed by the present invention upon acquired data; and

FIG. 14 relates operational modes to the missile body, showing a single pair in the plane of the image.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

One or more specific embodiments of the present invention will be described below. The present invention is not limited to the embodiments and illustrations contained herein, but include modified forms of those embodiments including portions of the embodiments and combinations of elements of different embodiments as come within the scope of the appended claims. In the development of any such actual implementation, as in any engineering or design project, numerous implementation-specific decisions must be made to achieve the developers' specific goals, such as compliance with system-related and business related constraints, which may vary from one implementation to another. Moreover, such a development effort might be complex and time consuming, but would nevertheless be a routine undertaking of design, fabrication, and manufacture for those of ordinary skill having the benefit of this disclosure.

The present invention that, in various aspects and embodiments, combines independent antenna patterns for target angle finding by a processing method employed by non-coherent Fresnel direction finding (“NCFDF”), uplink and satellite navigation channel satisfying volume demands. Not all embodiments, however, perform all three functionalities, and some might implement as few as one. Each spiral antenna can act as a quadrant of a three- or four-quad system. The antennas are conformal with radome surface.

And, in various aspects and embodiments, a technique is presented in which one may find target angle with one mode or the other (with trade offs) or both in a manner not previously exercised. Single modes (M1 or M2) can be used to find angle, and single arm spiral patterns may be combined far from the mechanical axis of the antenna. Both modes may be used to compensate for ambiguities.

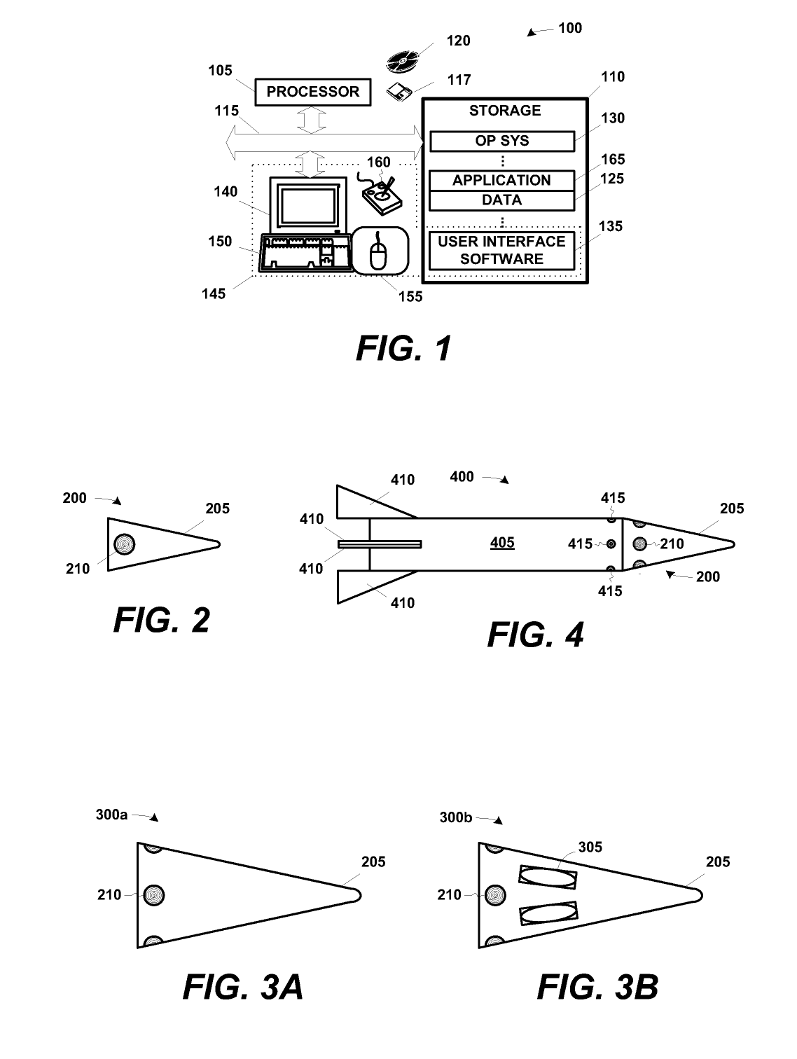

Certain aspects of some embodiments are computer implemented. FIG. 1 shows selected portions of the hardware and software architecture of a computing apparatus 100 such as may be employed in some aspects of the present invention. The computing apparatus 100 includes a processor 105 communicating with storage 110 over a bus system 115. The processor 105 may be any suitable processor known to the art. Given the volume of data and the rapidity of the processing, many embodiments will benefit from special purpose processors such as digital signal processors (“DSPs”) or processor sets (e.g., a general processor with a floating point co-processor). The storage 110 may include a hard disk and/or random access memory (“RAM”) and/or removable storage such as a floppy magnetic disk 117 and an optical disk 120.

The storage 110 is encoded with a data set 125, an operating system 130, user interface software 135, and an application 165. The user interface software 135, in conjunction with a display 140, implements a user interface 145. The user interface 145 may include peripheral I/O devices such as a keypad or keyboard 150, a mouse 155, or a joystick 160, but typically will not. The processor 105 runs under the control of the operating system 130, which may be practically any operating system known to the art. The application 165 is invoked by the operating system 130 upon power up, reset, or both, depending on the implementation of the operating system 130. The application 165, when invoked, performs the method of the present invention. The user may invoke the application in conventional fashion through the user interface 145.

Accordingly, some portions of the detailed descriptions herein are consequently presented in terms of a software implemented process involving symbolic representations of operations on data bits within a memory in a computing system or a computing device. These descriptions and representations are the means used by those in the art to most effectively convey the substance of their work to others skilled in the art. The process and operation require physical manipulations of physical quantities. Usually, though not necessarily, these quantities take the form of electrical, magnetic, or optical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise as may be apparent, throughout the present disclosure, these descriptions refer to the action and processes of an electronic device, that manipulates and transforms data represented as physical (electronic, magnetic, or optical) quantities within some electronic device's storage into other data similarly represented as physical quantities within the storage, or in transmission or display devices. Exemplary of the terms denoting such a description are, without limitation, the terms “processing,” “computing,” “calculating,” “determining,” “displaying,” and the like.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

FIG. 2 depicts an apparatus 200 in accordance with one particular embodiment of the present invention. The apparatus 200 includes a radome 205 and a conformal, spiral antenna 210 mounted in the radome 205. As shown in FIG. 3A-FIG. 3B, some embodiments such as the embodiments 300a, 300b, a plurality of conformal, spiral antennae 210 (only one indicated) may be used. The apparatus 200 may also use other acquisition techniques such NCFDF, RADAR, and LADAR.

In one particular embodiment shown in FIG. 4, the apparatus 200 is a missile 400. The missile 400 comprises a missile body 405 to which the radome 200 is joined. This particular embodiment employs a plurality of conformal, spiral antennae 210 (only one indicated), but the presently disclosed technique contemplates variation in this respect as well. For example, the variant in FIG. 3B may be used.

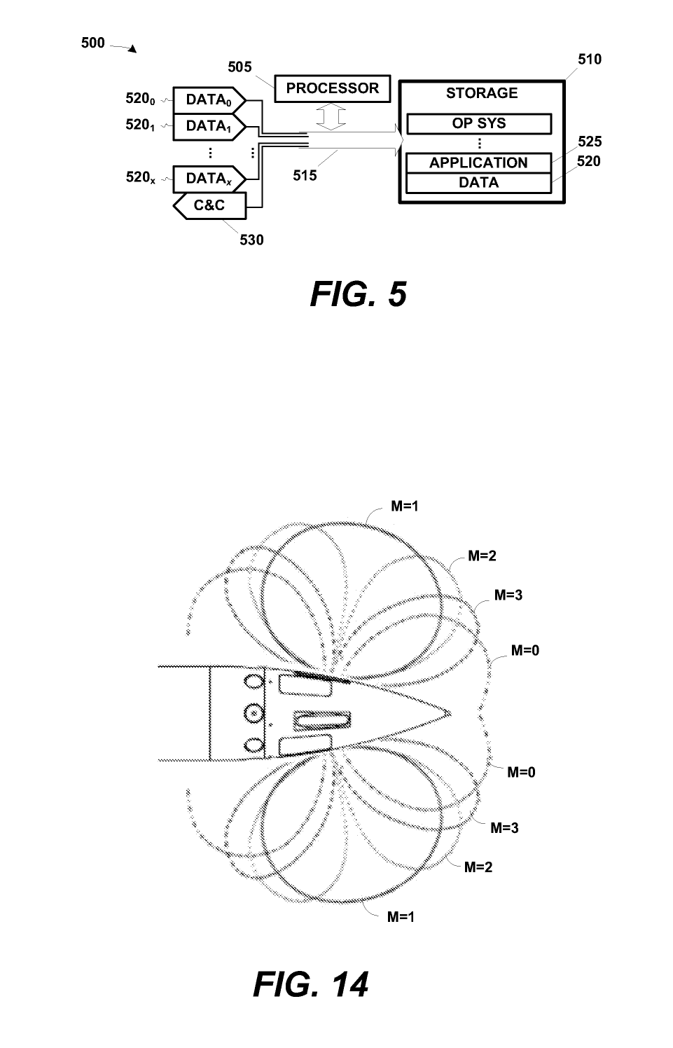

The missile 400 also includes means for guiding the missile responsive to information obtained through the spiral antennae 210. The guiding means includes a computer-implemented guidance and navigation control system 500, shown in FIG. 5, and means for affecting the heading of the missile. The affecting means may comprise a plurality of flight control surfaces 410 (e.g., fin surfaces), a plurality of attitude control jets 415, or both.

Turning now to FIG. 5, the computer-implemented guidance and navigation control system 500 includes a processor 505 communicating with a storage 510 over a bus 515. Note that, in this particular embodiment, the processor need not necessarily be a microprocessor or electronic controller. It may instead be, for example an appropriately programmed field programmable gate array (“FPGA”) or an application specific integrated circuit (“ASIC”). It also includes a plurality of data channels 520₀-520ₓ over which it receives data from the spiral antennae 210 and, if present other sensors. The application 525 operates on the data 520 to determine course adjustments to keep the missile 400 on target and issues command and control (“C&C”) signals 530 to the guiding means to effect that goal.

The manner in which the application 525 determines course adjustments will be implementation specific. In the illustrated embodiment, it first finds the angel to the target with a single mode—i.e., mode M1 or M2. It then compensates for ambiguity using both modes M1 and M2.

Thus, the presently disclosed technique deploys the apparatus 200, shown in FIG. 2, in implementing a method for use in operating a missile, comprising transmitting and receiving signals through a plurality of conformal, spiral antennae 210 mounted in a radome 205. In one particular embodiment, it then guides the missile 400, shown in FIG. 4, from information obtained from signals received through the antennae. In another aspect, the missile 400 can transmit and receive, uplink, and satellite positioning signals through a single antenna.

To further an understanding of the present invention, one particular implementation will now be discussed. This particular implementation is a variation including non-coherent Fresnel direction finding (“NCFDF”) capabilities. NCFDF is disclosed and claimed in U.S. Pat. No. 6,851,645, commonly assigned herewith, and is incorporated by reference below.

The presently disclosed technique allows several options of operation: a one arm spiral for a squinted M1 pattern; two arms and the usual broadside M1; or greater than one arm (2, 3, 4) to leverage M2. In all cases the presently disclosed technique seeks that region of the antenna pattern far from boresight, where a small change in angle produces a large change in amplitude, leveraging the amplitude monopulse method employed by NCFDF. The advance over the art is not only in the combination of the individual components, but also in and how they are exercised and combined.

These advances include use of spiral patterns at large angles with respect to their mechanical axis (e.g. 70° to 90°); M1 or M2 operation without both; both M1 & M2 where M1 serves as a guard channel for M2; monopulse combination of one or the other of these modes (not both, though both may be employed) from multiple antennas by which the presently disclosed technique constructs a difference pattern via digital processing with four independent beams; utilization of these broadband devices for reception and GPS (GPS @ ˜1.5 GHz requires a spiral be sufficiently large to accept this frequency) and uplink are all examples of non-standard utility of these periodic spiral antennas. This method and its combined device may be referred to as “Monopulse Spiral Mode Antenna Combining” (“MSMAC”).

Frequency independent antennas such as the various classes of spirals of interest here are desirable for their near-circular polarization (avoiding rejection of cross polarized linear), wide bandwidths (accepting signals over a wide range of frequencies), general power pattern independence, and conformal nature of microstrip designs. Typical off the shelf spirals come with relatively deep cavities (0.5″-2″), backing the antenna itself. This volume demand is excessive for limited real-estate applications such as in missiles. However, this cavity accommodates the antenna which radiates in both directions normal to its planar surface. Radiation in the unwanted backward direction presents a form of self-interference through backscattering in the forward direction, hampering clean operation of the device.

Placement of a cavity backing one-quarter wavelength (λ/4) from radiating spiral arms allows for a 180° path length phase shift with an additional 180° induced by E-field-vector flipping at the conductive wall, thereby satisfying boundary conditions requiring zero field on a conductor. Net phase adjustment upon return to the antenna is then 360° making return waves in-phase with radiating elements in keeping with image theory. However, the benefit of wideband periodic-spiral operation also means a variety of wavelengths must be accommodated, while the cavity wall is fixed at some distance, thereby ensuring a narrow band device because the cavity satisfies ideally only one frequency. Hence these cavities are typically loaded with absorber meant to remove interfering RF, not simply reflect in phase radiation. Cavity depth thus becomes a primary obstacle for radome surface mounting.

Several techniques are known for reducing cavity depth. Such techniques are disclosed in, for instance, U.S. Pat. No. 6,853,351 (“Mohuchy”); U.S. Pat. No. 5,815,122 (“Nurnberger et al.”); U.S. Pat. No. 5,589,842 (“Wang et al.”); and U.S. Pat. No. 6,407,721 (“Mehen et al”). U.S. Pat. No. 5,990,849 “Salvail et al.”) provides exemplary arm dimensions (col. 2, line 10-35). All consider ways of ameliorating the λ/4 cavity electrical-depth in an attempt to provide thinner radiators. A general description of spirals is given by U.S. Pat. No. 5,508,710 (“Wang et al.”) and “Antenna Engineering Handbook”, Johnson & Jasik, 2nd Ed. McGraw Hill, 1984, pg. 14-3.

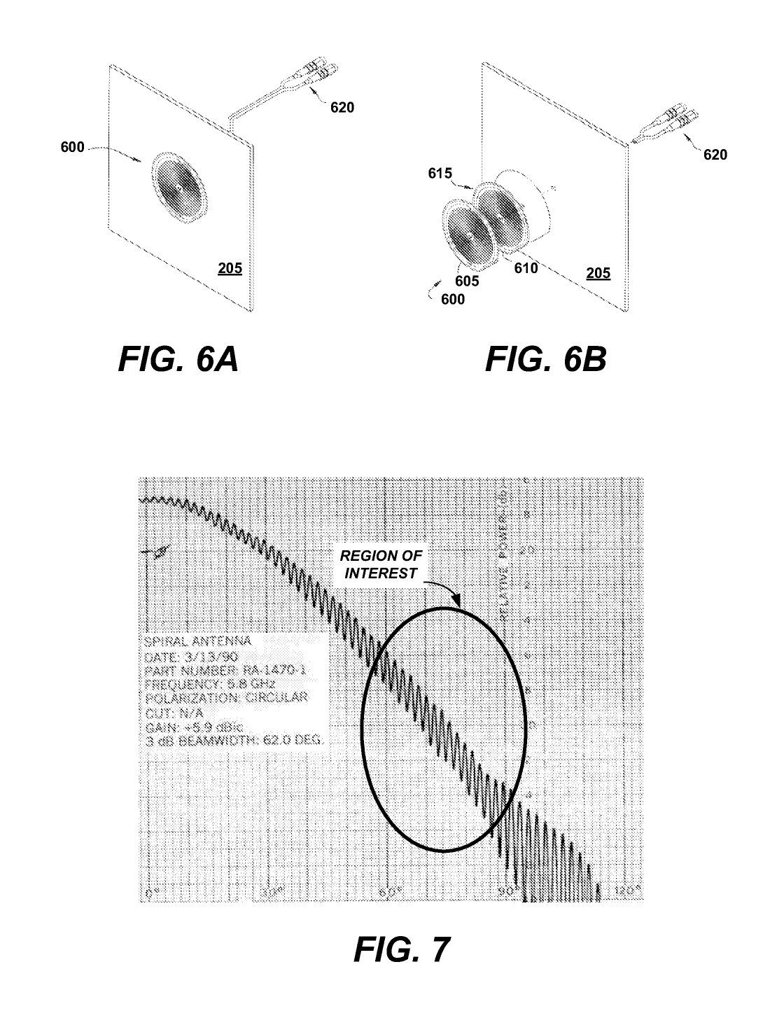

An exemplary spiral antenna 600 with reduced cavity, adapted from Mehen's disclosure, is shown in FIG. 6A-FIG. 6B. Mehen provides three spirals separated by dielectric. The first is that of the free-space coupling antenna with two spiral arms 605. The second set of conducting arms 610, separated from the first pair 605 by a dielectric (not designated), is a copy of the first, coupled to a fifth arm 615 printed on a second dielectric separation (also not designated). These final two spiral structures 610, 615 are connected by capacitive and inductive elements (also not designated), thus constituting a resonant cavity effectively absorbing radiated RF from the primary antenna, reducing the usual interference. Note the connectors 620 by which the antennae output may be communicated to the guiding means of the missile.

Mehen quotes total thickness for all layers combined as 12.2 mils with gain of 8 dBi on the mainbeam/mechanical axis. Further advances in thin cavity spirals is provided by Mohuchy's discovery that conversion of spiral arms from Archimedean to a logarithmic progression over the last ¾ turn more evenly distributes currents over wider portions of the arm surface. Reflections from these wider portions are then more evenly absorbed by materials within the cavity walls and beneath final turns of the radiators. He also notes an option to taper absorber to match low frequency terms, more efficiently absorbing RF. Note Mohuchy's disclosure regards reflective cavity backed antennas with depth ˜0.5 inch.

Nurnberger's method of cavity reduction uses slots in a conductive plane which then act like magnetic currents along the arm length allowing cavity reduction to 1/10 longest wavelength. Instead of an unloaded 1.5″ cavity for 2 GHz, Nurnberger converts this to 0.6″. Salvail notes the option to graduate dielectric constant of successive absorbing layers in the cavity.

As for a conformal surface, the cones of revolution upon which the spirals lie retain their properties upon distortion, such as flattening of a conical spiral into a planar one. While some property disturbance is anticipated this implies the curved surface of a radome remains suitable. Mehen also anticipates placement of such a device inside missiles and on contoured surfaces such as an aircraft fuselage. However, his employment of this device is in the conventional manner of a solitary unit making use of Mode 1 (and M2) normal to its surface, while the present technique employs the device as a set of four combined independent antennas through processing. Additionally, the present technique is most concerned for pattern behavior off axis, not on axis as is common to Mehen and the art in general. U.S. Pat. No. 5,589,842 notes experimentation with curved surface (half cylinder) placement resulting in adjustments to voltage standing wave ratio (“VSWR”) depending on bandwidth. Here, VSWR=1.5 for 330% bandwidth, VSWR=2.0 for 590% bandwidth, where this definition of bandwidth is as a factor over minimum frequency, i.e. 900% bandwidth of a 2 GHz device is 9*2=18 GHz.

With respect to beam squinting, as is standard for broadside radiating spirals, each arm is fed (or received) 180° out of phase at their input terminals. Given such inputs a voltage develops across neighboring arms when their differing path lengths allow in-phase radiation causing the spiral to radiate in the first mode (M1 sum pattern). Other modes are generated depending on phase shifts induced at input terminals. U.S. Pat. No. 4,797,684 (“Bernstein et al.”) provides a disclosure noting how to avoid squint due to phase offsets between arm excitations of multi-arm designs, hence imposing such a phase shift provides the squinted beam desired for one of the concepts of operation in the presently disclosed technique. Yet another option is revealed by (U.S. Pat. No. 6,018,327 (“Nokano et al.”) in which a single wire spiral is used. While Nakano employs this design as an array for beam steering (through phase adjustments to each antenna) his use is as with all such antennas, in the broadside direction, along its mechanical axis on boresight, while these devices are exercised at large angles off boresight.

Assessment of pattern behavior and potential accuracy can be derived from patterns available over the internet. For standard 2-arm M1 patterns, Rosendal Associates provides an example. http://www.rozendalassociates.com/ as shown in FIG. 7, which depicts a 2 GHz-18 GHz spiral power pattern. Note oscillations in the pattern over angle. Known as axial ratio this is due to rotation of a transmit horn under observation by the spiral in order to gauge how truly circular the spiral is. Given such antennas are in fact elliptical the result is what's shown at left. Notice more circular behavior on beam axis. We might draw boundaries intercepting top, bottom or middle of this fluctuation as that represents spiral response for a fixed target polarization, allowing beta formation and accuracy approximations.

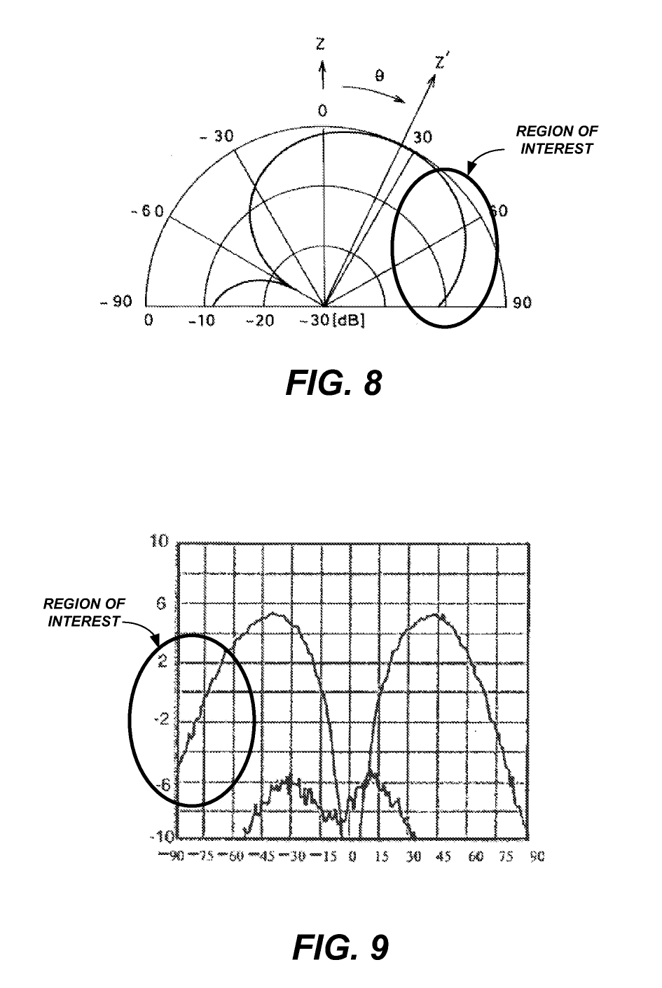

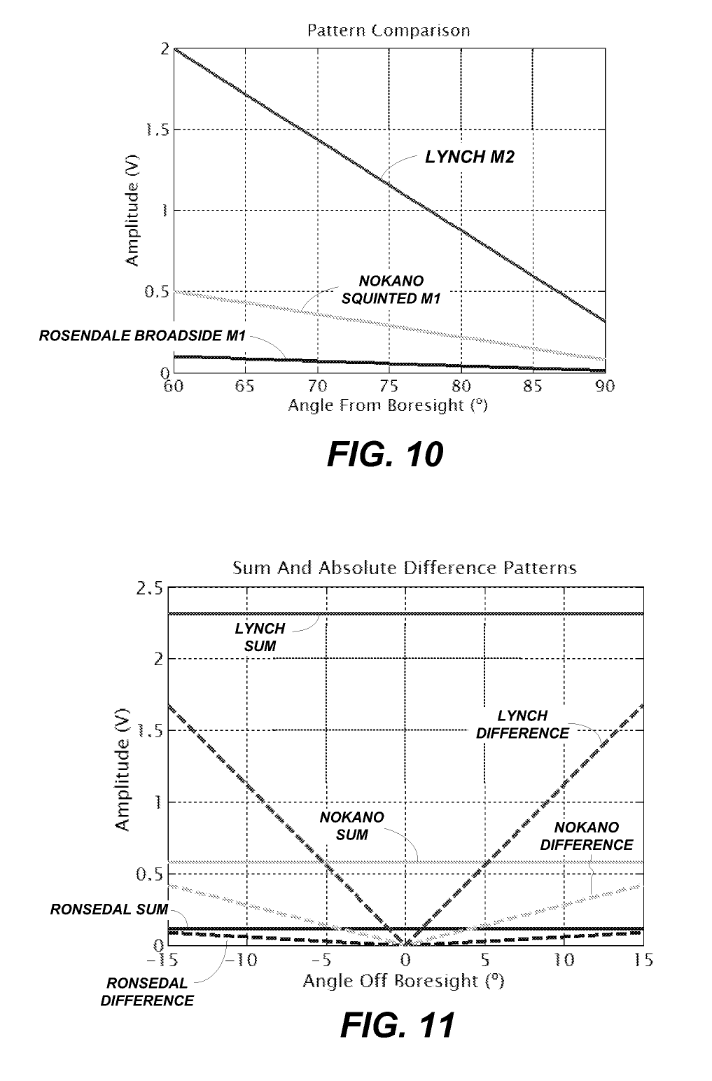

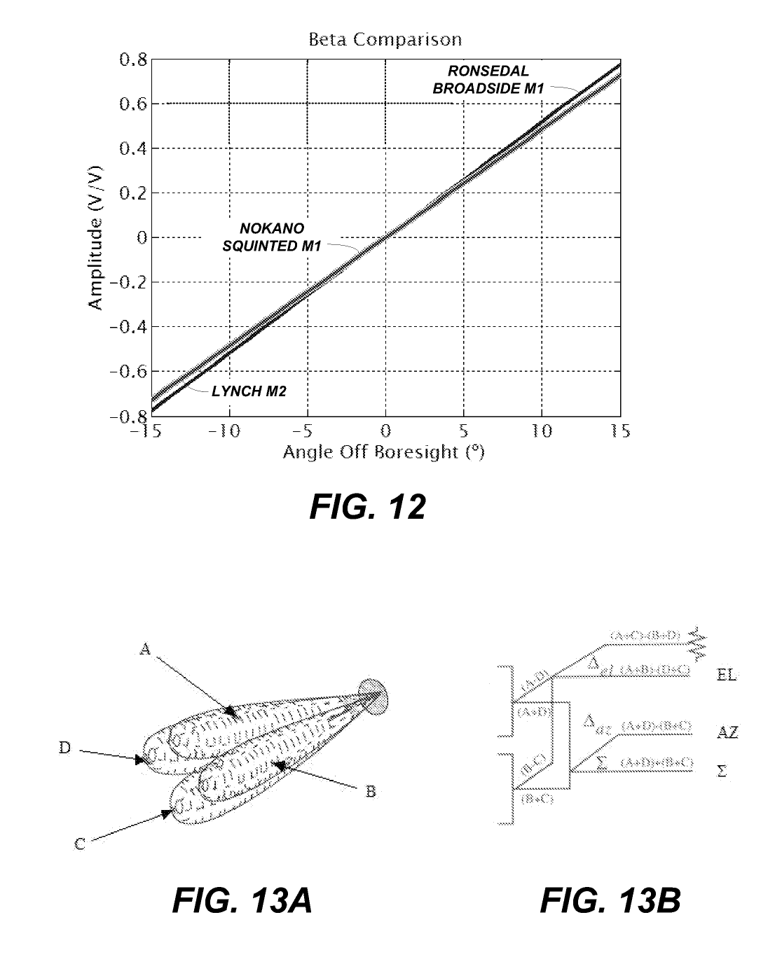

FIG. 8, reproduced from Nokano et al. and modified to indicate the region of interest, provides an example of strongly squinted single-arm beam patterns. (Note, squint angles induced by excitation phase offsets allow adjustment of M1 or M2 as desired.) FIG. 9, reproduced from Lynch et al. and also modified to show the region of interest, shows M2 patterns from another spiral antenna from U.S. Pat. No. 6,864,856 (“Lynch et al.”). Visual inspection of each plot presented in FIG. 7-FIG. 9 from 90° to 60° reveals the following shown in Table 1. Converting these values to amplitudes, comparing pattern sectors as shown in FIG. 10, sum and absolute value of difference as shown in FIG. 11, and resulting beta angle error curves shown in FIG. 12. Recall the beta curve provides a voltage value for each angle off boresight.

TABLE 1
Pattern Values @ 90° & 60°

| | 90° | 60° |
|---|---|---|
| Rosendal Standard M1 | −19 dB | −10 dB |
| Nokano Squinted M1 | −11 dB | −3 dB |
| Lynch M2 | −5 dB | +3 dB |

The plots show that one drawback with M1 is high loss (as with NCFDF) thus stressing receiver sensitivity more than results from employing M2. This may lead one to prefer both modes if compensation methods for ambiguities that arise are not correctable. Under such use, M1 may be used for broad angle reception of uplink, GPS and guard channel, while M2 is used for forward direction finding by combining multiple M2's, forming beta AZ/EL curves digitally. Thus depending on M2 for lower loss forward direction finding invites use of M1 as a guard channel through which to differentiate forward from backward direction. For squinted 1-arm spirals, employing both modes precludes single-arm operation as M2 is not available for single arms.

While U.S. Pat. No. 5,508,710 (“Wang”), in col. 6, at lines 57-63, notes use of high order modes (>M1) for improving power reception in the forward and aft directions as applied to automobile installations of his antenna (for ground based cell phone reception), he is not using a plurality of such antennas, nor has he need for direction finding by means noted here. His suggestion is merely one of optimizing power reception, leveraging power pattern geometry, matched to environments (cell towers on the ground). This is why he next notes using M1 only for GPS and satellite, again, because M1 pattern geometry matches the environment of a particular application (satellites above).

The angle reconstruction method described above is graphically represented in FIG. 13A-FIG. 13B. In practice both the azimuth (“AZ”) and elevation (“EL”) betas are produced in standard amplitude comparison monopulse. In calibration, a beta surface is generated, pairing AZ and EL in the usual manner.

The lowest wavelength response of spiral antennas is approximately equal to their maximum circumference times the mode used. Slightly more diameter will facilitate proper tuning These antennas radiate from regions corresponding to circles having circumference of mX, where m is the mode number. Hence a 2 GHz signal then requires 15 cm of circumference m=1, λ=(3e8/2e9) or 5.9 inches for M1, but twice this for M2. The diameter of such a circle is 1.9″ and 3.8″ respectively. Placement of a 2″ diameter device fits as shown in FIG. 14 with space to spare allocating M1 but not M2 at 2 GHz: m=2, λ=(3e8/2e9) or 11.8 inches. Note, however, that M2 for higher frequencies satisfied by the circumference rule will be radiated. For example for a 2″ diameter spiral, while M2 is suppressed at 2 GHz, the antenna's 5.9″ circumference supports M2 of half the noted wavelength, or 4 GHz (assuming satisfactory arm count is supplied to support it). Thus at a specific frequency, radiation for M1 will radiate from a region nearer the center than simultaneously for M2 further out.

Placement of these antennas may also be on the missile body fuselage, though metal surfaces will disturb pattern shape at high angles from mechanical boresight. RF absorber (or resistor cards, lumped elements, etc.) may be applied to reduce reflections form outer arms thus reducing axial ratio and taming impedance matching problems. As currently packaged the tilt of antennas assists gain in the forward direction. FIG. 15 relates modes to the missile body, showing a single pair in the plane of the image. Such a pair is the minimum requirement for monopulse angle generation.

The phrase “capable of” as used herein is a recognition of the fact that some functions described for the various parts of the disclosed apparatus are performed only when the apparatus is powered and/or in operation. Those in the art having the benefit of this disclosure will appreciate that the embodiments illustrated herein include a number of electronic or electro-mechanical parts that, to operate, require electrical power. Even when provided with power, some functions described herein only occur when in operation. Thus, at times, some embodiments of the apparatus of the invention are “capable of” performing the recited functions even when they are not actually performing them—i.e., when there is no power or when they are powered but not in operation.

The following documents are hereby incorporate by reference for all purposes as if set forth verbatim herein as modified and applied by the teachings set forth above:
U.S. Provisional Application Ser. No. 61/230,476, entitled “Monopulse Spiral Mode Antenna Combining”, filed Jul. 31, 2009, in the name of the inventor Brett A. Williams and commonly assigned herewith;
U.S. Pat. No. 4,797,684, entitled “Waveguide-Fed Microwave System Particularly for Cavity-Backed Spiral Antennas for the Ka Band”, issued Jan. 10, 1989, to Elisra Electronic Systems Ltd. as assignee of the inventors Joel Bernstein et al.;
U.S. Pat. No. 5,508,710, entitled “Conformal Multifunction Shared-Aperture Antenna”, issued Apr. 16, 1996, to Wang-Tripp Corporation as assignee of the inventors Johnson J. H. Wang et al.;
U.S. Pat. No. 5,589,842, entitled “Compact Microstrip Antenna with Magnetic Substrate”, issued Dec. 31, 1996, to Georgia Tech Research Corporation as assignee of the inventors Johnson J. H. Wang et al.;
U.S. Pat. No. 5,815,122, entitled “Slot Spiral Antenna with Integrated Balun and Feed”, issued Sep. 29, 1998, to The Regents of the University of Michigan as assignee of the inventors Michael W. Nurnberger et al.;
U.S. Pat. No. 5,990,849, entitled “Compact Spiral Antenna”, issued Nov. 23, 1999, to Raytheon Company as assignee of the inventors Gary Salvail et al.;
U.S. Pat. No. 6,018,327, entitled “Single-Wire Spiral Antenna”, issued Jan. 25, 2000, to Nippon Antenna Kabushiki Kaisha as assignee of the inventors Hisamatsu Nokano et al.;
U.S. Pat. No. 6,407,721, entitled “Super Thin, Cavity Free Spiral Antenna”, issued Jun. 18, 2002, to Raytheon Company as assignee of the inventors Mike Mehen et al.;
U.S. Pat. No. 6,851,645, entitled “Non-Coherent Fresnel Direction Finding Method and Apparatus”, issued Feb. 8, 2005, to Lockheed Martin Corp. as assignee of the inventors Brett A. Williams, et al.;
U.S. Pat. No. 6,853,351, entitled “Compact High-Power Reflective-Cavity Backed Spiral Antenna”, issued Feb. 8, 2005, to ITT Manufacturing Enterprises, Inc. as assignee of the inventors Wolodymyr Mohuchy;
U.S. Pat. No. 6,864,856, entitled “Low Profile, Dual Polarized/Pattern Antenna”, issued Mar. 8, 2005, to HRL Laboratories, LLC as assignee of the inventors Jonathan J. Lynch et al.; and
“Antenna Engineering Handbook”, Johnson & Jasik, 2nd Ed. McGraw Hill, 1984, pg. 14-3.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. An apparatus, comprising:
a radome or a missile body; and
a conformal, spiral antenna mounted in the radome or missile body.

2. The apparatus of claim 1, wherein the apparatus is a vehicle.

3. The apparatus of claim 2, wherein the vehicle is a missile.

4. A missile, comprising:
a missile body;
a radome joined with the missile body;
a plurality of conformal, spiral antennae mounted in the radome or the missile body;
means for guiding the missile responsive to information obtained through the spiral antennae.

5. The missile of claim 4, wherein the guiding means includes:
a computer-implemented guidance and navigation control system; and
means for affecting the heading of the missile.

6. The missile of claim 5, wherein the affecting means includes a plurality of flight control surfaces, a plurality of attitude control jets, or both.

7. The missile of claim 4, wherein the guiding means:
finds angle with a single mode; and
compensates for ambiguities using two modes.

8. The missile of claim 7, wherein the guiding means combines single arm spiral patterns may be combined far from mechanical axis of antenna.

9. The missile of claim 4, wherein the missile employs non-coherent Fresnel direction finding.

10. A method for use in operating a missile, comprising transmitting and receiving signals through a plurality of conformal, spiral antennae mounted in a radome or a missile body.

11. The method of claim 10, further comprising guiding the missile responsive to data gleaned from signals received though the spiral antennae.

12. The method of claim 10, further comprising at least one of:
finding a target angle with a first mode or a second mode;
combining the first mode, the second mode, or both the first and second modes with an arm spiral patterns far from mechanical axis of antenna; and
using both the first and second modes to compensate for ambiguities.

13. The method of claim 10, wherein sending and transmitting signals includes sending and transmitting at least one of target, uplink, and satellite positioning system signals.

14. A method for use in operating a missile, comprising:
transmitting and receiving signals through a plurality of conformal, spiral antennae mounted in a radome or a missile body; and
guiding the missile from information obtained from signals received through the antennae.

15. The method of claim 14, wherein guiding the missile includes:
finding a target angle with a first mode or a second mode;
combining the first mode, the second mode, or both the first and second modes with an arm spiral patterns far from mechanical axis of antenna; and
using both the first and second modes to compensate for ambiguities.

16. A method comprising transmitting and receiving target, uplink, and satellite positioning system signals through a single antenna.

17. The method of claim 16, wherein the antenna is mounted in the radome.

18. The method of claim 17, wherein the radome is joined to a missile body.

19. The method of claim 17, wherein the antennae is a conformal, spiral antenna mounted in the radome.
